(19) United States
(12) Patent Application Publication
(10) Pub. No.: US 2004/0129123 A1
(43) Pub. Date: Jul. 8, 2004

(54) Gift wrap work station

(76) Inventor: Joseph W. Miller, Manchester, MO (US)

Correspondence Address: Joseph W. Miller, 16 Timberleigh Ct, Manchester, MO, 63021, US

(21) Appl. No.: 10/337,189

(22) Filed: Jan. 6, 2003

(51) Int. Cl. B26D 1/04

(52) U.S. Cl. 83/574; 30/317; 83/649

(57) ABSTRACT

A work station for gift wrapping comprising a compartment for storage of rolls of paper, wrapping accessories and tools, a top surface for placement of objects to be wrapped, a removable roll holding means attached to an end panel, a tape dispenser holding means attached to another end panel, an end and a bottom panel. The work station is set up by installing the roll holding means on one of the end panels, and by placing a common scotch tape dispenser on a holding means that allows a user to easily dispense tape from the dispenser. A roll of paper is removed the compartment and easily inserted onto the roll holding means, and during a dispensing operation keeps the edge of the paper aligned with the adjacent end panel. An article for wrapping is placed on top of the paper after it has been dispensed and is cut to length and width using a common letter opener type cutter. Tape is easily pulled from tape dispenser while holding the wrapped article. The roll, the roll holding means, and the tape dispenser are easily removed and stored in the compartment ready to use for the next occasion. The work station may have handle for carrying or storing on a wall.

### BACKGROUND OF THE INVENTION

The present invention relates to new and useful improvements for gift wrapping.

It is a relatively common experience to have a need to gift wrap boxes and articles bought as presents and gifts for birthdays, graduation, anniverseries, etc, but especially during the Christmas and Hannakuh holidays. It is also a common occurance to gift wrap wherever it may be convenient, practical, or the easiest to do—on the living room floor, a kitchen table, or on a bed in the privacy of a closed bedroom. It is also common to be surrounded by numerous long rolls of wrapping paper and the gifts to be wrapped, name tags, a tape dispenser, scissors, bows, and ribbons. As the packages are progessively wrapped, it is common to switch to different colored and decorative paper instead of using the same paper for all packages. The typical consumer is continually measuring, cutting, applying tape, many times until finished, only to find himself surrounded by partly used rolls, partly used webs, and equipment that must be put away for the next occasion. Thus there is a need to make this frequent experience more user friendly and convenient.

Heretofore, the prior art has addressed this problem only partially and unsuccessfully. There are numerous organizers for the gift wrap rolls, ribbon, bows, scissors, tape dispensers, etc., but this does not address the problems of efficiency and methodology. In U.S. Pat. No. 5,480,080 to Ferguson, in U.S. Pat. No. 5,850,960 to Cadwell, and in U.S. Pat. No. 5,322,201 to Garr, the prior art teaches improvements for tearing and cutting wrapping paper from the long rolls, but this also does not help the overall problem.

In U.S. Pat. No. 5,301,854, to Scobey, a storing and dispensing container is disclosed that addresses some of these unsolved problems with gift wrapping. This invention discloses a method for storing the rolls inside a carton that is equipped with a cutting edge for cutting the wrap once it is dispenced from the carton. A roll holding means comprising a long rod held between slots on each end of the carton allows dispensing of the paper. Additionally, it provides a method to hold a tape dispenser to allow easy application of scotch tape dispenser. The invention does not provide a firm, hard surface that is required for simple and efficient wrapping It also requires one to tear the wrap from the roll before placing the package on the apron and paper. This requires additional handling of the paper, of the package to be wrapped and the container dispenser. Thus the present invention is concerned with several improvements in the prior art.

### SUMMARY OF THE INVENTION

Accordingly, besides the advantages of the existing prior art several objects and advantages of the present invention are:

to provide a portable, light weight work station with a surface that can be used for supporting packages during the wrapping process;

to provide a portable light weight means to store and organize rolls of wrapping paper, wrap accessories such as bows, ribbon, name tags, tape dispensers, scissors and other items;

to provide an improved, user friendly, method of dispensing from a variety of gift wrapping paper wound on rolls,

to provide a visual aid in measuring the proper length and width of wrapping paper to be cut from a wound roll of paper;

to provide an improved, user friendly, method of tearing and cutting sheets of wrap paper from wound rolls of paper;

to provide a user friendly method for holding, securing, and removing a tape dispenser attached to the work station;

to provide an improved, user friendly, method of tape dispensing while gift wrapping;

to provide a work station that allows a package to be simultaneously wrapped with paper from a wrap dispenser while being supported on a work surface and to cut the paper after the wrapping process.

to provide a simple and economical method to install and remove a roll holding means from the work station;

### BRIEF DESCRIPTION OF THE DRAWINGS

FIG. 1 is a perspective view of a preferred embodiment of the invention showing several features of the work station: rolls of gift paper in storage, a roll of paper installed on the roll holding means and being partially dispensed on the top surface, and the tape dispenser.

FIG. 2 is a plan view of FIG. 1 showing the roll holding means and the tape dispenser holding means. A roll of paper and a tape dispenser is shown in phantom.

FIG. 3 is an end view of FIG. 1 showing a left and right tape dispenser holding means, with a tape dispenser on the right holding tab.

FIG. 4 is a side view of a typical letter opener type of cutter used with the invention.

### DESCRIPTION OF THE PREFERRED EMBODIMENT

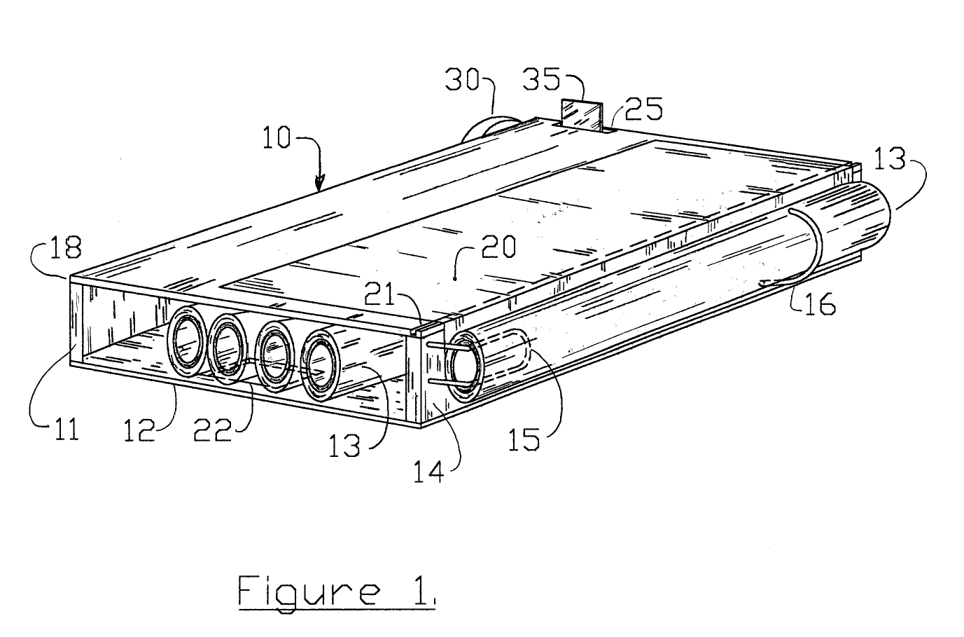

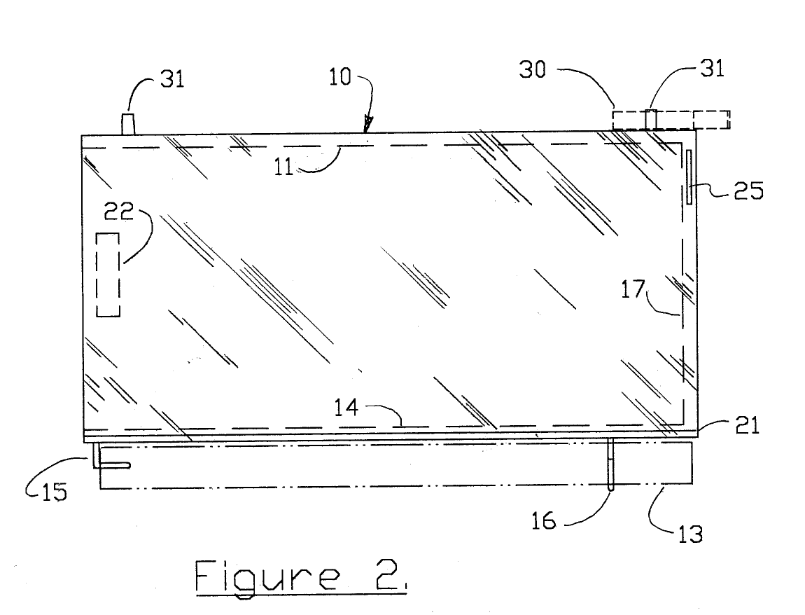

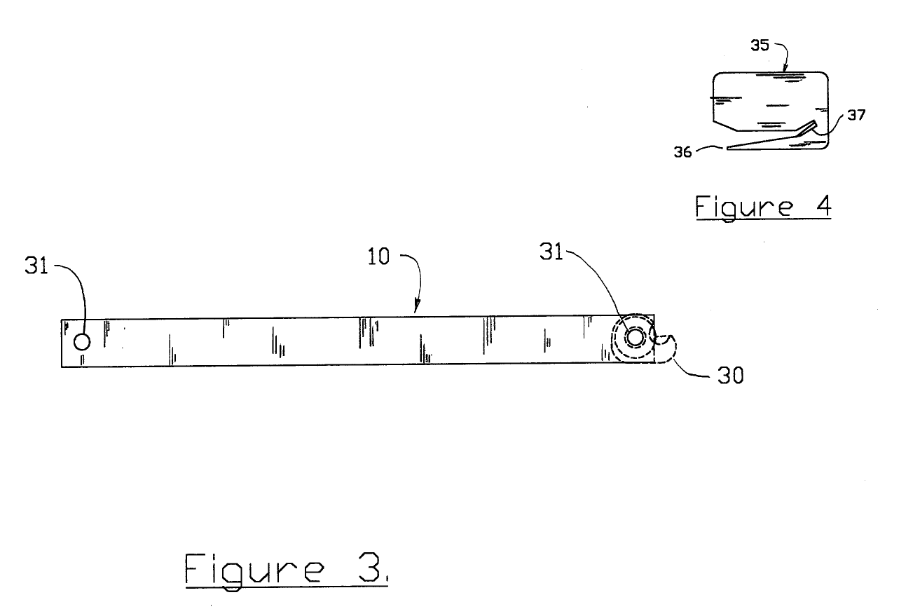

According to one aspect of the present invention as shown in FIG. 1, FIG. 2, and FIG. 3, a container or work station 10, comprises end panels 11,14, and 17, a top surface 18, and bottom panel 12. One end is left open for receiving rolls of gift wrapping paper 13 and other items useful for wrapping. Initially all rolls 13 are stored in the compartment 10 of the invention, along with other tools, such as a letter opener type cutter, a scotch tape dispenser 30, scissors, ribbons, bows, name tags, etc. In FIG. 4 a letter opener type of cutter 35 is shown and is a necessary item and supplied with the invention. It is assumed that the cutter will be supplied along with the removable, attachable roll holding means 15 and 16 and furnished in a cloth type bag with a draw string for storing and safe keeping. Additional items useful for wrapping can be placed in the bag and its contents can then be put in the compartment and be ready for use.

When one is ready to wrap a gift, the work station is first set up by installing the two components of the roll holding means, 15 and 16. These are preferrably made from 3/16″-¼″ steel rod and are simply inserted into receiving holes provided in the end panel 14. Next an ordinary scotch tape dispenser 30 is placed on one of the cylindrical holding tabs 31. The tape dispenser 30 is provided with a hole approximately 1″ in diameter and is inserted onto the tapered holding tab 31. The tab is located vertically so that the bottom edge of the dispenser 30, when placed on the tab 31, rests on the surface supporting the container. The tab is also located horizontally so that dispenser extends beyond the end panel. The tape dispenser is now held firmly in place and allows easy one handed tape dispensing. For left handed dispensing, a left hand tab 31 may also be used.

The work station is now ready for use. A roll of paper is selected from the compartment 10 and placed onto the roll holding means. The element 15 is shaped to be inserted into the core of a roll of paper 13, while the other element 16 supports the other end of the roll 13 and partially encompasses the roll 13. The configuration of these elements provide a convenient, simple, and economical method for loading, unloading, and dispensing from a roll 13. The element 15 restricts the axial motion of the roll and aligns the paper with the edge of an end panel. The element 16 helps hold the roll radially during a dispensing action and allows the paper to unwind onto to the top surface 18. It should be noted that the paper is unwound with the decorative side down. This is an important feature that allows a user to place a box to be wrapped on top of the paper and rotate the box and the paper simultaneously, thus literally “wrapping” the box by winding the paper around the box while the roll is unwinding. This is an easy operation to perform because the top surface supports the weight of the box and the hands are free to hold the paper and the box. It is also convenient and user friendly because the correct amount of paper to be dispensed has already been determined without pre-measuring. One simply has to cut the paper from the roll. This is now easily performed by using a simple letter opener type of cutter 35. The cutter 35 is placed against the surface of end panel 14, with the point 36 directed against the edge of the paper, and using the end panel 14 as a guide, move the cutter into the paper forcing the blade 37 of the letter opener 35 to cut the paper. This type of cutter provides a quick, clean cut and is much easier to use than scissors. If the paper needs to be cut to width, the box and paper can be turned 90 degrees, the paper is unwound from the box and laid flat on the top surface 18 and cut as before using the letter opener type cutter 35. The paper has now been cut to length and width and is ready to be wrapped around the box. The paper is wrapped around the box and held in place by one hand while the other hand is easily and conventiently able to dispense tape from the dispenser 30 because it is securely held by the tab31. Since it gnerally requires four to six tape dispensing operations to securely tape the gift wrapped box, the dispensing operation is now an easy task. The roll of paper may now be unloaded and removed from the work station 10, placed in the compartment for storing, and a new decorative roll is loaded and ready for another gift.

Another feature of the invention is that it is very portable and may be used in many different locations other than a table or on a floor. Many people wrap gifts in the privacy of their bedroom and use the bed as a table. The present invention provides all of the conveniences of wrapping as above by providing a sturdy, work surface, ergonomically designed paper and tape dispensing, organization and storage. Another feature of the invention is that the work surface provides a visual aid for measuring the amount of paper to dispense. The preferable size of the work station is about 36″ in length, 24″ in width, and 2-6″ in depthh. When a box is placed on the compartment 10, it may be rolled lengthwise and widthwise over the top surface to guage and determine the girth of the box and its corresponding size of paper needed for wrapping. The paper can then be correctly dispensed, cut, and ready to for wrapping.

Additional features may also be added to provide more convenience, such as adding a handle 22 for carrying and storing the invention on a wall. A longitudinal slot 21 cut into the top surface next to end panel 14 may provide a better guide for the cutter 35 during a cutting operation. A slot 25 to hold and receive the cutter 35 so the cutter has a place to be put and does not get lost may also be added and be a useful improvement to the present invention.

I claim:

1. A wrap work station for holding and dispensing materials employed for wrapping boxes and other articles comprising:
a) a rectangular compartment providing a storage means for storing rolls of wrapping paper, ribbon, name tags, tape, wrapping tools and other related items, comprising a top surface for supporting said articles, end panels, a bottom panel, and an opening for inserting items into said compartment,
b) a roll holding means for holding and dispensing rolls of paper onto said top surface, wherein said holding means is supportably attached to the exterior of one of said end panels,
c) a tape dispenser holding means for removably securing common scotch tape dispenser to the exterior of another one of said end panels.

2. The invention as claimed in claim 1, wherein said roll holding means removably attaches to said end panel.

3. The invention as claimed in claim 2, wherein said roll holding means comprises a first element that supports said roll of paper tangentially at one end of said roll, and a second element that restricts the axial movement of said roll whereby the edge of said paper is aligned with one of said end panels during a roll dispensing operation;

4. The invention as claimed in claim 3, wherein said first element comprises a cylindrical rod or bar protruding perpendicular from said end panel, said second element comprises a round rod shaped for insertion into the core of said roll of paper whereby roll is axially restricted in one direction, thus allowing said roll to be loaded and unloaded from said roll holding means.

5. The invention as claimed in claim 1, wherein said tape dispenser holding means employs a frictional fit between the core of said tape dispenser and a cylindrical element attached perpendicularly to said end panel.

6. The invention as claimed in claim 1, wherein said work station comprises a holding means for carrying or for hanging said work station in storage.

7. The invention as claimed in claim 1, and comprising one or more divider plates within said compartment providing additional storage compartments.

8. The invention as claime in claim 2 wherein said roll holding means comprises a rod held between two of said end panel extended from said compartment and employed as a means for holding said rod.

9. The invention as claimed in claim 1 whereby said top surface includes a longitudinal slot that provides a guide for receiving a common letter opener type of cutting device for cutting the paper during a cutting operation.

10. The invention as claimed in claim 2, werein said roll holding means comprises a rod held between two of said end panels extendend from said compartment and employed as a means for holding said rod.

11. A storing and dispensing container for rolls of paper comprising a top surface, end panels, a bottom panel, and an opening for inserting rolls of paper into said container,
a.) a roll holding means for holding and dispensing rolls of paper onto said top surface, wherein said roll holding means is supportably attached to the exterior of one of said end panels,
b.) a tape dispenser holding means for removably securing common scotch tape dispensers to the exterior of another said end panel.

12. The invention as claimed in claim 11 wherein said roll holding means removably attaches to said end panel.

13. The invention as claimed in claim 12 wherein said roll holding means comprises a first element that supports the base of said roll tangentially and extends partially around the circumference of said roll whereby the radial movement of said roll is restricted by said element and its attached said end panel, and a second element shaped for insertion into the core of said roll.

14. The invention as claimed in claim 11 wherein said tape dispenser holding means employs a frictional fit between the core of said tape dispenser and a cylindrical element attached perpendicular to said end panel.

15. The invention as claimed in claim 11 wherein said container comprises a holding means for carrying or for hanging said container on a wall for storage.

16. The invention as claimed in claim 11 and comprises a cutter holding means comprising a slot cut into the top surface of said container and of sufficient depth and width to recieve and hold upright a common letter opener type of cutter.

17. The invention as claimed in claim 11 and comprises a cutting slot cut into the top surface of said container whereby a common letter opener cutter may be inserted into said slot whereby said slot provides a guide for said cutter during a cutting operation of said paper.

18. A method for cutting sheets of material from a continuous roll of material comprising a letter opener type of cutter and a guided means for said cutter whereby said cutter is held against said means during a cutting operation.

19. The method as claimed in claim 18 whereby said guided means comprises a longitudinal slot in a longitudinal planar member, said slot is of sufficient width and depth for recieiving and containing said cutter during a cutting operation.
